(19) United States
(12) Patent Application Publication
(10) Pub. No.: US 2015/0172151 A1
(43) Pub. Date: Jun. 18, 2015

(54) PORTABLE WIRELESS SELF-HOSTED CONDITION MONITORING WEB SERVER AND METHOD OF USE

(71) Applicant: Aktiebolaget SKF, Goteborg (SE)

(72) Inventors: Travis J. Bottalico, San Diego, CA (US); Johannes Izak Boerhout, San Diego, CA (US)

(73) Assignee: Aktiebolaget SKF, Goteborg (SE)

(21) Appl. No.: 14/132,138

(22) Filed: Dec. 18, 2013

(51) Int. Cl. H04L 12/26; H04W 24/08; H04L 29/08; G06F 17/22

(52) U.S. Cl. CPC H04L 43/08; G06F 17/2247; H04W 24/08; H04L 67/02

(57) ABSTRACT

A condition monitoring device that collects data indicative of a condition of a machine. The condition monitoring device includes a main controller; a condition monitoring sensor system (which includes at least one condition sensor); a signal processor provided in signal communication between the sensor system and the main controller; and an HTTP web server, an Internet accessible communication circuit, and, a digital storage device, each in signal communication with the main controller. Condition data is stored in a web page compatible format, including HyperText Markup Language (HTML) formatted data, JavaScript formatted data, JSON, XML, Cascading Style Sheets (CSS) formatted data, image files, and any other API supporting format. The HTTP web server compiles collected and stored condition data into webpage formats compatible for access and viewing through a variety of browsers, including standard and mobile browsers, enabling interaction with the condition monitoring device using any browser enabling device.

### FIELD OF THE INVENTION

The present invention relates to a condition monitor and associated method of use. More specifically, the condition monitor includes a data conveyance system which utilizes a variety of data formats in conjunction with an HTTP web server application providing an adaptive data dissemination process enabling receipt of condition data using any web based browser.

### BACKGROUND OF THE INVENTION

### Discussion of the Related Art

Continuous runtime of, and predictive maintenance windows, for machinery is essential to optimizing reliability and minimizing impact on productivity. Understanding the condition of the machinery is beneficial in determining and optimizing maintenance schedules for the machinery.

Condition monitors are typically employed for obtaining data indicative of a condition of an operating machine. The condition monitors senses and obtains parameters of conditions in machinery (vibration, temperature, etc.), in order to identify a significant change, which is indicative of a developing fault. The use of conditional monitoring allows maintenance to be scheduled, or other actions to be taken to prevent failure and avoid its consequences. Condition monitoring has a unique benefit in that conditions that would shorten normal lifespan can be addressed before they develop into a major failure. Condition monitoring techniques are normally used on rotating equipment and other machinery (pumps, electric motors, internal combustion engines, presses), while periodic inspection using non-destructive testing techniques and fit for service (FFS) evaluation are used for stationary plant equipment such as steam boilers, piping and heat exchangers.

Condition monitors collect and store data in a predetermined format dictating a specific application for receiving and deciphering the data indicative of the conditions of the machinery. This requirement can be limiting, as it requires dedicated software based upon a selected protocol (commonly proprietary to the manufacturer), which is commonly installed on a specific computing device. Additionally, the dedicated software can be limiting on the end user's ability to manipulate, index, or in any other way manage the condition data obtained by the condition monitoring device.

Separately, web based data platforms utilize data manipulation platforms enabling flexible data output to any browser enabling computing device.

HyperText Markup Language (HTML) is the main markup language for creating web pages and other information that can be displayed in a web browser.

HTML is written in the form of HTML elements consisting of tags enclosed in angle brackets (like <html>), within the web page content. HTML tags most commonly come in pairs like <hl>and </hl>, although some tags represent empty elements and so are unpaired, for example <img>. The first tag in a pair is the start tag, and the second tag is the end tag (they are also called opening tags and closing tags). In between these tags web designers can add text, further tags, comments and other types of text-based content.

The purpose of a web browser is to read HTML documents and compose them into visible or audible web pages. The browser does not display the HTML tags, but uses the tags to interpret the content of the page.

HTML elements form the building blocks of all websites. HTML allows images and objects to be embedded and can be used to create interactive forms. It provides a means to create structured documents by denoting structural semantics for text such as headings, paragraphs, lists, links, quotes and other items. It can embed scripts written in languages such as JavaScript, which affect the behavior of HTML web pages.

JavaScript (JS) is an interpreted computer programming language. As part of web browsers, implementations allow client-side scripts to interact with the user, control the browser, communicate asynchronously, and alter the document content that is displayed. It has also become common in server-side programming, game development and the creation of desktop applications.

JavaScript is a prototype-based scripting language with dynamic typing and has first-class functions. Its syntax was influenced by C. JavaScript copies many names and naming conventions from Java, but the two languages are otherwise unrelated and have very different semantics. The key design principles within JavaScript are taken from the Self and Scheme programming languages. It is a multi-paradigm language, supporting object-oriented, imperative, and functional programming styles.

The application of JavaScript to uses outside of web pages—for example, in Portable Document Format (PDF) documents, site-specific browsers, and desktop widgets—is also significant. Newer and faster JavaScript VMs and frameworks built upon them (notably Node.js) have also increased the popularity of JavaScript for server-side web applications.

Web browsers can also refer to Cascading Style Sheets (CSS) to define the appearance and layout of text and other material. The W3C, maintainer of both the HTML and the CSS standards, encourages the use of CSS over explicit presentational HTML.

Cascading Style Sheets (CSS) is a style sheet language used for describing the presentation semantics (the look and formatting) of a document written in a markup language. Its most common application is to style web pages written in HTML and XHTML, but the language can also be applied to any kind of XML document, including plain XML, SVG and XUL.

CSS is designed primarily to enable the separation of document content (written in HTML or a similar markup language) from document presentation, including elements such as the layout, colors, and fonts. This separation can improve content accessibility, provide more flexibility and control in the specification of presentation characteristics, enable multiple pages to share formatting, and reduce complexity and repetition in the structural content (such as by allowing for tableless web design). CSS can also allow the same markup page to be presented in different styles for different rendering methods, such as on-screen, in print, by voice (when read out by a speech-based browser or screen reader) and on Braille-based, tactile devices. It can also be used to allow the web page to display differently depending on the screen size or device on which it is being viewed. While the author of a document typically links that document to a CSS file, readers can use a different style sheet, perhaps one on their own computer, to override the one the author has specified.

CSS specifies a priority scheme to determine which style rules apply if more than one rule matches against a particular element. In this so-called cascade, priorities or weights are calculated and assigned to rules, so that the results are predictable.

Extensible Markup Language (XML) is a markup language that defines a set of rules for encoding documents in a format that is both human-readable and machine-readable. XML is designed utilizing standards based upon free open standards. The design goals of XML emphasize simplicity, generality, and usability over the Internet. It is a textual data format with strong support via Unicode for the languages of the world. Although the design of XML focuses on documents, it is widely used for the representation of arbitrary data structures, for example in web services. Many application programming interfaces (APIs) have been developed to aid software developers with processing XML data, and several schema systems exist to aid in the definition of XML-based languages.

JavaScript Object Notation (JSON), is an open standard format that uses human-readable text to transmit data objects consisting of attribute—value pairs. It is used primarily to transmit data between a server and web application, as an alternative to XML.

Although originally derived from the JavaScript scripting language, JSON is a language-independent data format, and code for parsing and generating JSON data is readily available in a large variety of programming languages.

Thus, what is desired is a condition monitoring device capable of exporting data using a flexible data presentation and/or dissemination format.

### SUMMARY OF THE INVENTION

The present invention is directed towards an adaptive data conveyance condition monitoring apparatus.

A first aspect of the present invention introduces an adaptive data conveyance condition monitoring apparatus comprising:

a condition monitor housing;

a main controller circuit in signal communication with a signal processor and digital a memory device, wherein at least one of the signal processor and the main controller comprising an instruction set that stores data obtained from the condition monitoring sensor system in at least one of:
web application programming interface (API) enabling formatted data,
HyperText Markup Language (HTML) formatted data,
JavaScript formatted data,
JavaScript Object Notation (JSON),
Extensible Markup Language (XML),
Cascading Style Sheets (CSS) formatted data; and
image files,

a condition monitoring sensor system in signal communication with the signal processor;

a microprocessor circuit operating in accordance with a hypertext transfer protocol (HTTP) web server application, wherein the microprocessor circuit is one of integrated into the main controller and in communication with the main controller;

a microprocessor circuit operating in accordance with a hypertext transfer protocol (HTTP) web server application, wherein the microprocessor circuit is one of:
integrated into the main controller, and
in communication with the main controller; and

a bidirectional data communication circuit enabling communication between the main controller and at least one externally located browser enabling computing device.

In a second aspect of the present invention, the bidirectional communication circuit includes a wired transceiver.

In yet another aspect of the present invention, the wired transceiver employs at least one of Ethernet communication protocol, universal serial bus (USB) communication protocol, parallel communication protocol, and the like.

In another aspect of the present invention, the bidirectional communication circuit includes a wireless transceiver.

In yet another aspect of the present invention, the wireless transceiver employs at least one of wide area networking (WAN), local area networking (LAN), 802.11 radio transmission protocol, cellular transmission protocol (including but not limited to frequency division multiple access (FDMA), code division multiple access (CDMA), Global System for Mobile Communications (GSM), General Packet Radio Service (GPRS), CDMA-One, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN), and the like), Bluetooth, ZigBee, and the like.

In yet another aspect of the present invention, the microprocessor circuit operating in accordance with a hypertext transfer protocol (HTTP) web server application further comprises a compilation instruction set comprising a step of compiling the stored data into a webpage format.

In yet another aspect, the HTTP web server application is adapted for viewing on desktop devices, mobile devices, and the like.

In yet another aspect, the HTTP web server application is compatible with multiple browser platforms, such as INTERNET EXPLORER™, FIREFOX™, CHROME™, SAFARI™ and the like.

In yet another aspect, the mobile devices can include smartphones, laptop computers, tablet computing devices, personal data assistants, and the like.

Another aspect of the present invention is directed towards a method of use of an adaptive data conveyance condition monitoring apparatus, the method comprising steps of:

employing an adaptive data conveyance condition monitoring apparatus to monitor conditions of a machine, the adaptive data conveyance condition monitoring apparatus comprising:
a condition monitor housing;
a main controller circuit in signal communication with a signal processor and digital a memory device, wherein at least one of the signal processor and the main controller comprising an instruction set that stores data obtained from the condition monitoring sensor system in at least one of:
   web application programming interface (API) enabling formatted data,
   HyperText Markup Language (HTML) formatted data,
   JavaScript formatted data,
   JavaScript Object Notation (JSON),
   Extensible Markup Language (XML),
   Cascading Style Sheets (CSS) formatted data; and
image files,
a condition monitoring sensor system in signal communication with the signal processor;
a microprocessor circuit operating in accordance with a hypertext transfer protocol (HTTP) web server application, wherein the microprocessor circuit is one of integrated into the main controller and in communication with the main controller;
a microprocessor circuit operating in accordance with a hypertext transfer protocol (HTTP) web server application, wherein the microprocessor circuit is one of:
integrated into the main controller, and
in communication with the main controller; and
a bidirectional data communication circuit enabling communication between the main controller and at least one externally located browser enabling computing device;

storing data obtained from the condition monitoring sensor system in at least one of:
web application programming interface (API) enabling formatted data,
HyperText Markup Language (HTML) formatted data,
JavaScript formatted data,
JavaScript Object Notation (JSON),
Extensible Markup Language (XML),
Cascading Style Sheets (CSS) formatted data, and
image files;

compiling the stored data into at least one web page format for display as at least one web page;

communicating the at least one web page to a data recipient.

In yet another aspect, the method further comprises a step of submitting a GET request to the condition monitor to receive the at least one web page.

In yet another aspect, the step of compiling stored data can be further refined by including a step of receiving a request for specific data from a data recipient.

In yet another aspect, the method further comprises a step of requesting missing assets from the condition monitor.

In yet another aspect, the method further comprises a step of embedding a condition monitoring application within at least one webpage for use within a browser.

In yet another aspect, the method further comprises a step of parsing a response obtained from the adaptive data conveyance condition monitoring apparatus.

In yet another aspect, the method further comprises a step of constructing a response from HTML files stored in the memory device of the adaptive data conveyance condition monitoring apparatus.

In yet another aspect, the method further comprises a step of constructing a response from at least one of Cascading Style Sheets (CCS), JavaScript, and image files stored in the memory device of the adaptive data conveyance condition monitoring apparatus.

In yet another aspect, the method further comprises a step of building an application in the browser. The browser automatically adjusts to accommodate a browser and device screen size.

In yet another aspect, the method further comprises a step of submitted a request to receive condition data to the adaptive data conveyance condition monitoring apparatus, wherein the request is submitted through a browser on the browser enabling computing device.

In yet another aspect, the method further comprises a step of submitted an asynchronous request to receive condition data to the adaptive data conveyance condition monitoring apparatus, wherein the request is submitted through a browser on the browser enabling computing device.

In yet another aspect, the method further comprises a step of submitted a request to receive missing assets or condition data to the adaptive data conveyance condition monitoring apparatus, wherein the request is submitted through a browser on the browser enabling computing device.

In yet another aspect, the method further comprises a step of identifying the specific adaptive data conveyance condition monitoring apparatus.

In yet another aspect, the method further comprises a step of receiving compiling data from multiple adaptive data conveyance condition monitoring apparatus.

The adaptive data conveyance condition monitoring apparatus provides several advantages over the currently available condition monitoring apparatus. Initially, the adaptive data conveyance condition monitoring apparatus enables the apparatus to communicate obtained condition data from the condition monitoring sensor system to any browser enabling device through a browser and respective data protocols.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents an exemplary schematic diagram illustrating basic components of an adaptive data conveyance condition monitoring apparatus in data communication with an exemplary browser enabled device;

FIG. 2 presents an exemplary schematic diagram introducing components of the adaptive data conveyance condition monitoring apparatus and interaction of the components enabling adaptive manipulation of collected data for dissemination to a variety of browser enabled devices; and

FIG. 3 presents an exemplary condition monitoring data dissemination flow diagram.

Like reference numerals refer to like parts throughout the several views of the drawings.

### DETAILED DESCRIPTION OF REPRESENTATIVE EMBODIMENTS

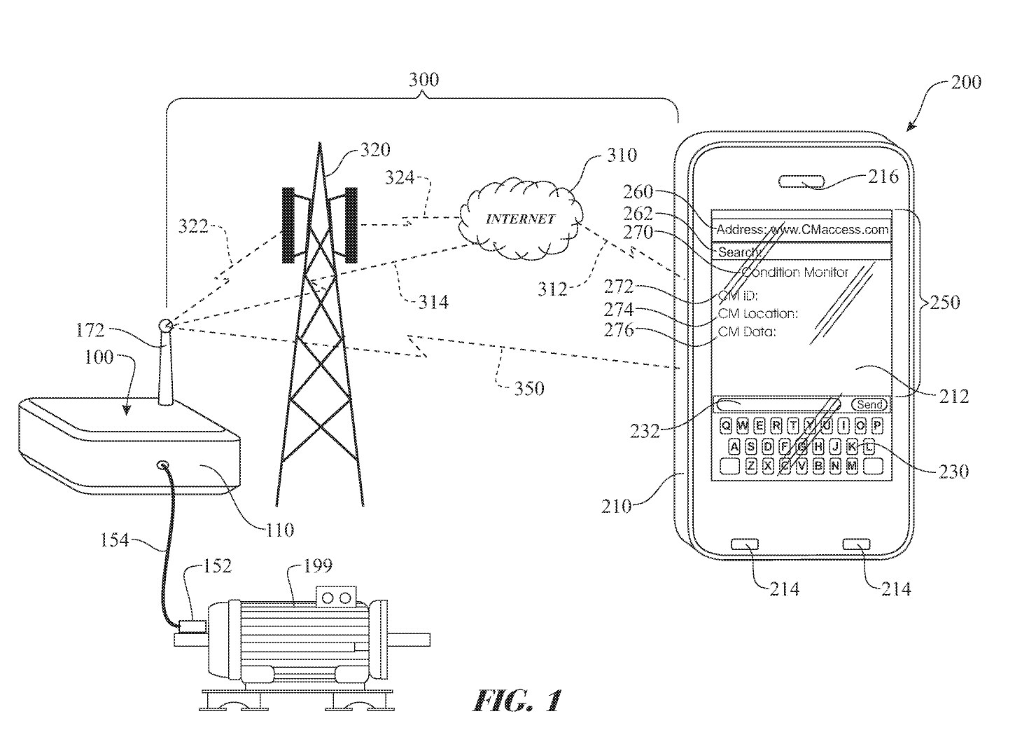

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

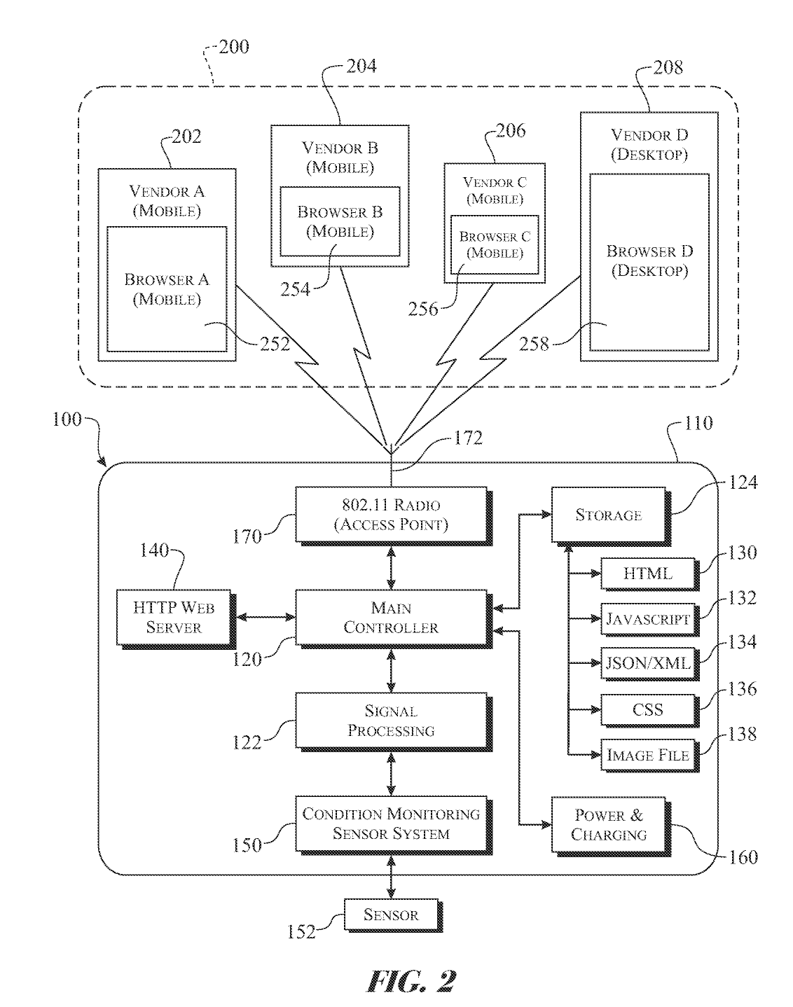

An adaptive data conveyance condition monitoring apparatus 100 provides an adaptive solution for monitoring conditions of a monitored machine 199 is illustrated in the exemplary schematic diagram presented in FIG. 1 and in the exemplary schematic condition monitoring component block diagram presented in FIG. 2. The adaptive data conveyance condition monitoring apparatus 100 monitors one or more parameters indicative of conditions of the monitored machine 199 by way of one or more sensors 152. A sensor communication link 154 provides signal communication between each sensor 152 and the adaptive data conveyance condition monitoring apparatus 100, more specifically a condition monitoring sensor system 150 of the adaptive data conveyance condition monitoring apparatus 100. The adaptive data conveyance condition monitoring apparatus 100 includes communication circuitry for conveying collected data to a data recipient. The communication circuitry can include any of a variety of protocols for conveying the data, wherein the communication circuitry and associated protocols will be discussed later within this disclosure.

Details of exemplary components integrated into the adaptive data conveyance condition monitoring apparatus 100 and their respective interactions are best presented in FIG. 2. The components of the adaptive data conveyance condition monitoring apparatus 100 are assembled to or within a condition monitor housing 110. The primary brains of the adaptive data conveyance condition monitoring apparatus 100 is a condition monitor main controller 120. Power is obtained and managed throughout the adaptive data conveyance condition monitoring apparatus 100 by a power and charging circuit 160. It is understood that the adaptive data conveyance condition monitoring apparatus 100 can obtain electrical power from a stored power source, such as any form of a battery, a super-capacitor, and the like; an external power source, such as a wall outlet, a power line, a photovoltaic material and respective circuitry, a power generator, and the like; or any other suitable power source. Power can be provided to the condition monitor main controller 120, where the condition monitor main controller 120 disseminates the electrical power to the other electrically powered components (as shown in FIG. 2) or the power and charging circuit 160 can manage and distribute the power directly to the other electrically powered components.

The condition monitor main controller 120 is provided in signal communication with each of a signal processor 122, a digital data storage device 124, a HTTP web server 140, and a wireless transceiver 170. An antenna 172 can be included and in signal communication with the wireless transceiver 170 to improve and preferably optimize the data transmission quality and signal strength. The signal processor 122 is provided, in turn, in signal communication with the condition monitoring sensor system 150. Machine condition data is obtained by and received from each of the at least one sensors 152. The condition monitoring sensor system 150 manages and collects the machine condition data from each of the at least one sensors 152. The sensors 152 can monitor temperature, wear, vibration, power loss, acceleration, lubrication, operational runtime, and the like. Power can be provided to each of the at least one sensors 152 by either the condition monitoring sensor system 150, the condition monitor main controller 120, the power and charging circuit 160, or any other suitable power network. The received data is processed through the signal processor 122. The processed data is subsequently forwarded to the main controller 120. It is understood that the signal processor 122 can be independent of the condition monitor main controller 120 (as illustrated) or integrated into a single component. The data is converted into at least one of HyperText Markup Language (HTML) formatted data 130, JavaScript formatted data 132, JavaScript Object Notation (JSON) and/or Extensible Markup Language (XML) formatted data 134, Cascading Style Sheets (CSS) formatted data 136, image files 138, and/or any other suitable web supporting format. The converted data is stored in a digital data storage device 124. It is understood that the digital data storage device 124 can be independent of the condition monitor main controller 120 (as illustrated) or integrated with the condition monitor main controller 120 as a single component.

A Hypertext Transfer Protocol (HTTP) web server 140 is integrated into the adaptive data conveyance condition monitoring apparatus 100. The HTTP web server 140 enables delivery of the condition data in a web content format that can be accessed through the Internet 310. The web server 140 hosts a website accessible by a data recipient. The HTTP web server 140 can additionally be used for data storage (replicating or replacing the digital data storage device 124) and/or running local applications. It is also understood that the HTTP web server 140 can be independent of the condition monitor main controller 120 (as illustrated) or with the condition monitor main controller 120 as a single component.

Communication between the adaptive data conveyance condition monitoring apparatus 100 and a browser enabling computing device 200 is provided through a wireless transceiver 170. The wireless transceiver 170 provides wired and/or wireless communication with external devices using any suitable communication protocol(s). The wireless transceiver 170 can be integrated in signal communication with the condition monitor main controller 120 (as shown) and/or the HTTP web server 140, providing an information communication link between the adaptive data conveyance condition monitoring apparatus 100 and the browser enabling computing device 200. The exemplary embodiment illustrates a wireless communication interface 300, wherein the wireless communication interface 300 can be accomplished in any of a variety of wired and/or wireless protocols or combinations thereof.

When employing a wired communication interface, the wired transceiver employs at least one of Ethernet communication protocol, universal serial bus (USB) communication protocol, parallel communication protocol, and the like.

When employing a wireless communication interface, the wireless transceiver employs at least one of the following protocols: wide area networking (WAN), local area networking (LAN), 802.11 radio transmission protocol, cellular transmission protocol (including but not limited to frequency division multiple access (FDMA), code division multiple access (CDMA), Global System for Mobile Communications (GSM), General Packet Radio Service (GPRS), CDMA-One, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN), and the like), Bluetooth, ZigBee, and the like.

The schematic diagram illustrated in FIG. 1 presents three exemplary embodiments for transmitted condition data from the adaptive data conveyance condition monitoring apparatus 100 to the browser enabling computing device 200. A first exemplary embodiment is accomplished using a direct wired or wireless communication, referred to as a cellular condition monitor—browser enabled device communication link 350, between the adaptive data conveyance condition monitoring apparatus 100 and the browser enabling computing device 200. The preferred embodiment would employ an 802.11 transceiver as illustrated in FIG. 2. Alternate embodiments for the cellular condition monitor—browser enabled device communication link 350 can include Ethernet, USB, Serial interface, and the like (wired), Bluetooth, WiFi, and the like (wireless), or any other suitable direct communication interface. A second exemplary embodiment is accomplished using a WAN or LAN connection, wherein the adaptive data conveyance condition monitoring apparatus 100 accesses the Internet 310 via a wireless condition monitor—browser enabled device communication link 314, which, in turn, is accessed by the browser enabling computing device 200 through a wireless Internet—browser enabled device communication link 312. One exemplary solution for broad coverage environments, wireless condition monitor—browser enabled device communication link 312 is a WAN. A second exemplary solution for closer proximity environments, the wireless condition monitor—browser enabled device communication link 312 is a LAN. A third exemplary solution employs a cellular communication network 320, wherein the adaptive data conveyance condition monitoring apparatus 100 initially connects with the cellular communication network 320 through a cellular condition monitor—cellular network communication link 322, which, in turn, merges into the Internet 310 through a cellular network—Internet communication link 324. It is understood that the cellular network—Internet communication link 324 can be a wired or wireless connection. Once connected to the Internet 310, the network provides bidirectional communication between the adaptive data conveyance condition monitoring apparatus 100 and the browser enabling computing device 200.

The browser enabling computing device 200 includes circuitry and instruction set directing an integrated microprocessor to operate in accordance with a browser 250. The browser 250 can be any commercially available software or customized software enabling interaction of websites/web pages through the Internet 310. Examples of browsers 250 include INTERNET EXPLORER™, FIREFOX™, CHROME™, SAFARI™ and the like. The browser enabling computing device 200 can include elements integrated into a commonly offered form factor of a browser enabling computing device. Primary components integrated into the browser enabling computing device 200 include a browser enabled device housing 210, enabling integration and support of other components; a browser enabled device display 212, which is preferably a Liquid Crystal Display (LCD) and could be either a viewing display or a touch sensitive screen; and a mobile device keypad 230, which can be a physical component or a virtual component utilizing the functionality of the touch screen. A data entry window 232 can be included providing a user with a reference for data entry. Additional components can include at least one browser enabled device audio input device 214 and a browser enabled device audio output device 216 enabling audio input and output interfaces for the user.

The exemplary browser 250 introduces a portion of features, including a browser address window 260 and a browser search data entry window 262. The exemplary browser is illustrated displaying a portion of the data features associated with a typical website for accessing the adaptive data conveyance condition monitoring apparatus 100. The displayed information obtained from the interaction with the adaptive data conveyance condition monitoring apparatus 100 includes a condition monitor application reference 270, a condition monitor identifier 272, a condition monitor location reference 274, and a condition monitor data 276. It is understood that the condition monitor data 276 can be displayed in an array format, including having searchable, sortable, and exportable functionality.

The flexibility offered by the inclusion of the combination of the HTTP web server 140 and the various stored data forms: HTML formatted data 130, JavaScript formatted data 132, JavaScript Object Notation (JSON) and/or Extensible Markup Language (XML) formatted data 134, CSS formatted data 136, image files 138, or any other suitable formatted data enables the adaptive data conveyance condition monitoring apparatus 100 to transfer data indicative of a condition of an operating machine to any browser enabled platform. It is understood that the data would be stored in any suitable format capable of acting as a web Application Programming Interface (API). The exemplary communication embodiment presented in FIG. 2 illustrates the flexibility generated by the inventive platform. The exemplary illustration presents a single adaptive data conveyance condition monitoring apparatus 100 in bidirectional communication with several different browser enabled devices 202, 204, 206, 208, and each device employing a different browser 252, 254, 256, 258. The vendor “A” mobile device 202 is employing a mobile device browser “A” 252, wherein the vendor “A” mobile device 202 would be representative of a smartphone. The vendor “B” mobile device 204 is employing a mobile device browser “B” 254, wherein the vendor “B” mobile device 204 would be representative of a tablet. The vendor “C” mobile device 206 is employing a mobile device browser “C” 256, wherein the vendor “C” mobile device 206 would be representative of a laptop computer. The vendor “D” desktop device 208 is employing a desktop device browser “D” 258, wherein the vendor “D” desktop device 208 would be representative of any fixed station computing device, such as a desktop or a workstation.

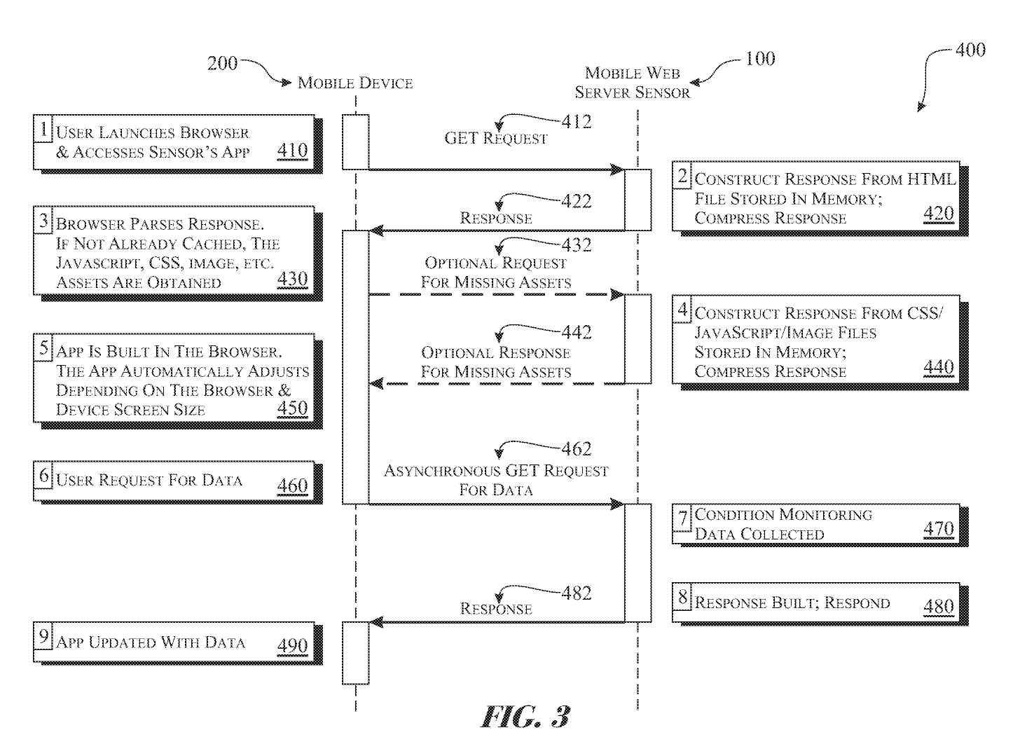

An exemplary condition monitoring data dissemination flow diagram 400 is presented in FIG. 3. The process employs an adaptive data conveyance condition monitoring apparatus 100, a browser enabling computing device 200, and a communication link providing signal conveyance therebetween. The adaptive data conveyance condition monitoring apparatus 100 is installed to monitor at least one condition parameter of a monitored machine 199. The adaptive data conveyance condition monitoring apparatus 100 obtains condition data in accordance to at least one of a preprogrammed set of instructions and a directive from an external source. The data recipient launches a browser 250 on the browser enabling computing device 200 in accordance with a browser initiation step 410. The data recipient utilizes the browser 250 to access the sensors application. The request is forwarded to the adaptive data conveyance condition monitoring apparatus 100 using a request conveyance 412. Upon receipt of the request, the adaptive data conveyance condition monitoring apparatus 100 constructs a response utilizing HTML formatted data 130 stored within the digital data storage device 124 in accordance with a response construction from HTML files step 420. The response is compressed and returned to the browser enabling computing device 200 in a format of a webpage dataset in accordance with a response conveyance 422. The browser 250 receives the webpage dataset and parses the response in accordance with a browser parsing response step 430. The browser 250 reviews the data to determine of the webpage dataset is complete. In a condition where the browser 250 determines the data is missing assets, the browser 250 issues a request to the adaptive data conveyance condition monitoring apparatus 100 to return missing assets in accordance with an optional request for missing assets conveyance 432. The adaptive data conveyance condition monitoring apparatus 100 constructs a response from the HTML formatted data 130, the JavaScript formatted data 132, the CSS formatted data 136, the Image Files 138, the JavaScript Object Notation (JSON) and/or Extensible Markup Language (XML) formatted data 134, and any other suitable formatted data in accordance with a response construction from CSS/JavaScript/Image Files step 440. The adaptive data conveyance condition monitoring apparatus 100 returns the missing asset data to the browser enabling computing device 200 in accordance with an optional response for missing assets conveyance 442. The application for receiving, viewing, managing, and manipulating the condition parameters data is constructed within the browser 250 in accordance with an application construction by browser step 450. The web-enabled application is sized by the browser 250 for use with the specific device screen size, window size, and other operating parameters. The user can elect to request specific data, such as over a desired period of time, a specific condition, a trend of the parameter, updated machine condition data, and the like in accordance with a user request for data step 460. The request is communicated from the browser enabling computing device 200 to the adaptive data conveyance condition monitoring apparatus 100 through an asynchronous request for data conveyance 462. The adaptive data conveyance condition monitoring apparatus 100 collects the requested data either from the condition monitoring sensor system 150 and/or the digital data storage device 124 in accordance with a condition monitoring data collection step 470. The HTTP web server 140 subsequently constructs a response in accordance with data supporting the request in accordance with an updated response construction step 480. The adaptive data conveyance condition monitoring apparatus 100 returns the missing asset data to the browser enabling computing device 200 in accordance with a convey updated response conveyance 482. The application is updated with the provided machine condition data in accordance with an application updated with newly collected data step 490.

The HTTP web server 140 enables communication between the adaptive data conveyance condition monitoring apparatus 100 and any browser enabled device exclusive of any specific software. This provides flexibility to the data recipient. Access to the adaptive data conveyance condition monitoring apparatus 100 can be governed by passwords or other security enabling features.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

LISTING OF REFERENCE NUMBERS

| Ref. No. | Description |
|---|---|
| 100 | adaptive data conveyance condition |
| | monitoring apparatus |
| 110 | condition monitor housing |
| 120 | condition monitor main controller |
| 122 | signal processor |
| 124 | digital data storage device |
| 130 | HTML formatted data |
| 132 | JavaScript formatted data |
| 134 | JavaScript Object Notation (JSON) |
| | and/or Extensible Markup Language |
| | (XML) formatted data |
| 136 | CSS formatted data |
| 138 | Image Files |
| 140 | HTTP web server |
| 150 | condition monitoring sensor system |
| 152 | sensor |
| 154 | sensor communication link |
| 160 | power and charging circuit |
| 170 | wireless transceiver |
| 172 | antenna |
| 199 | monitored machine |
| 200 | browser enabling computing device |
| 202 | vendor “A” mobile device |
| 204 | vendor “B” mobile device |
| 206 | vendor “C” mobile device |
| 208 | vendor “D” desktop device |
| 210 | browser enabled device housing |
| 212 | browser enabled device display |
| 214 | browser enabled device audio input |
| | device |
| 216 | browser enabled device audio output |
| | device |
| 230 | mobile device keypad |
| 232 | data entry window |
| 250 | browser |
| 252 | mobile device browser “A” |
| 254 | mobile device browser “B” |
| 256 | mobile device browser “C” |
| 258 | desktop device browser “D” |
| 260 | browser address window |
| 262 | browser search data entry window |
| 270 | condition monitor application |
| | reference |
| 272 | condition monitor identifier |
| 274 | condition monitor location reference |
| 276 | condition monitor data |
| 300 | wireless communication interface |
| 310 | Internet |
| 312 | wireless Internet - browser enabled |
| | device communication link |
| 314 | wireless condition monitor - browser |
| | enabled device communication link |
| 320 | cellular communication network |
| 322 | cellular condition monitor - cellular |
| | network communication link |
| 324 | cellular network- Internet |
| | communication link |
| 350 | cellular condition monitor - browser |
| | enabled device communication link |
| 400 | condition monitoring data |
| | dissemination flow diagram |
| 410 | browser initiation step |
| 412 | request conveyance |
| 420 | response construction from HTML |
| | files step |
| 422 | response conveyance |
| 430 | browser parsing response step |
| 432 | optional request for missing assets |
| | conveyance |
| 440 | response construction from CSS/ |
| | JavaScript/Image Files step |
| 442 | optional response for missing assets |
| | conveyance |
| 450 | application construction by browser |
| | step |
| 460 | user request for data step |
| 462 | asynchronous request for data |
| | conveyance |
| 470 | condition monitoring data collection |
| | step |
| 480 | updated response construction step |
| 482 | convey updated response |
| | conveyance |
| 490 | application updated with newly |
| | collected data step |

What is claimed is:

1. An adaptive data conveyance condition monitoring apparatus, comprising:
a condition monitor housing;
a main controller circuit in signal communication with a signal processor and digital a memory device, wherein at least one of said signal processor and said main controller comprising an instruction set that stores data obtained from said condition monitoring sensor system in at least one of:
web application programming interface (API) enabling formatted data,
HyperText Markup Language (HTML) formatted data,
JavaScript formatted data,
JavaScript Object Notation (JSON),
Extensible Markup Language (XML),
Cascading Style Sheets (CSS) formatted data; and
image files,
a condition monitoring sensor system in signal communication with said signal processor;
a microprocessor circuit operating in accordance with a hypertext transfer protocol (HTTP) web server application, wherein said microprocessor circuit is one of integrated into said main controller and in communication with said main controller;
a microprocessor circuit operating in accordance with a hypertext transfer protocol (HTTP) web server application, wherein said microprocessor circuit is one of:
integrated into said main controller, and
in communication with said main controller; and
a bidirectional data communication circuit enabling communication between said main controller and at least one externally located browser enabling computing device.

2. The adaptive data conveyance condition monitoring apparatus as recited in claim 1, wherein said bidirectional communication circuit includes a wireless transceiver.

3. The adaptive data conveyance condition monitoring apparatus as recited in claim 1, wherein said microprocessor circuit operating in accordance with said hypertext transfer protocol (HTTP) web server application further comprises a compilation instruction set comprising a step of compiling said stored data into a webpage format.

4. The adaptive data conveyance condition monitoring apparatus as recited in claim 3, wherein said webpage format is adapted for viewing on desktop devices and mobile devices.

5. The adaptive data conveyance condition monitoring apparatus as recited in claim 3, wherein said webpage format is compatible for viewing on multiple cross platform browsers.

6. The adaptive data conveyance condition monitoring apparatus as recited in claim 1, wherein said microprocessor circuit operating in accordance with said hypertext transfer protocol (HTTP) web server application further comprises an embedded application, wherein said embedded application comprises an instruction set enabling interaction between said browser and said main controller.

7. A method of use of an adaptive data conveyance condition monitoring apparatus, the method comprising steps of:
employing an adaptive data conveyance condition monitoring apparatus to monitor conditions of a machine, the adaptive data conveyance condition monitoring apparatus comprising:
a condition monitor housing;
a main controller circuit in signal communication with a signal processor and digital a memory device, wherein at least one of the signal processor and the main controller comprising an instruction set that stores data obtained from the condition monitoring sensor system in at least one of:
web application programming interface (API) enabling formatted data,
HyperText Markup Language (HTML) formatted data,
JavaScript formatted data,
JavaScript Object Notation (JSON),
Extensible Markup Language (XML),
Cascading Style Sheets (CSS) formatted data; and
image files,
a condition monitoring sensor system in signal communication with the signal processor;
a microprocessor circuit operating in accordance with a hypertext transfer protocol (HTTP) web server application, wherein the microprocessor circuit is one of integrated into the main controller and in communication with the main controller;
a microprocessor circuit operating in accordance with a hypertext transfer protocol (HTTP) web server application, wherein the microprocessor circuit is one of:
integrated into the main controller, and
in communication with the main controller; and
a bidirectional data communication circuit enabling communication between the main controller and at least one externally located browser enabling computing device;
storing data obtained from the condition monitoring sensor system in at least one of:
web application programming interface (API) enabling formatted data,
HyperText Markup Language (HTML) formatted data,
JavaScript formatted data,
JavaScript Object Notation (JSON),
Extensible Markup Language (XML),
Cascading Style Sheets (CSS) formatted data, and
image files;
compiling the stored data into at least one web page format for display as at least one web page;
communicating the at least one web page to a data recipient.

8. The method of use of an adaptive data conveyance condition monitoring apparatus as recited in claim 7, the method further comprising steps of:
accessing a web page using a browser enabling device;
submitting a request for condition data from said adaptive data conveyance condition monitoring apparatus through said web page;
conveying said request for condition data from said browser enabling device to said adaptive data conveyance condition monitoring apparatus;
responding to said request for condition data by said adaptive data conveyance condition monitoring apparatus, wherein said adaptive data conveyance condition monitoring apparatus compiles data into said at least one web page format for display as said at least one web page in accordance with said request; and
conveying said at least one web page format to said browser enabling device.

9. The method of use of an adaptive data conveyance condition monitoring apparatus as recited in claim 7, the method further comprising steps of:
identifying a scenario where data is missing assets; and
requesting said adaptive data conveyance condition monitoring apparatus provide said missing assets.

10. The method of use of an adaptive data conveyance condition monitoring apparatus as recited in claim 7, the method further comprising a step of:
embedding a condition monitoring application within at least one webpage for use within a browser.

11. The method of use of an adaptive data conveyance condition monitoring apparatus as recited in claim 7, the method further comprising a step of:
building an application within said browser;
automatically sizing a presentation of said condition data to accommodate a screen size of said display and said browser.

12. The method of use of an adaptive data conveyance condition monitoring apparatus as recited in claim 7, the method further comprising a step of:
constructing a response from HTML files stored in the memory device of the adaptive data conveyance condition monitoring apparatus.

13. The method of use of an adaptive data conveyance condition monitoring apparatus as recited in claim 7, the method further comprising a step of:
constructing a response from at least one of Cascading Style Sheets (CCS), JavaScript, and image files stored in the memory device of the adaptive data conveyance condition monitoring apparatus.

14. A method of use of an adaptive data conveyance condition monitoring apparatus, the method comprising steps of:
employing an adaptive data conveyance condition monitoring apparatus to monitor conditions of a machine, the adaptive data conveyance condition monitoring apparatus comprising:
a condition monitor housing;
a main controller circuit in signal communication with a signal processor and digital a memory device, wherein at least one of the signal processor and the main controller comprising an instruction set that stores data obtained from the condition monitoring sensor system in at least one of:
web application programming interface (API) enabling formatted data,
HyperText Markup Language (HTML) formatted data,
JavaScript formatted data,
JavaScript Object Notation (JSON),
Extensible Markup Language (XML),
Cascading Style Sheets (CSS) formatted data, and
image files;
a condition monitoring sensor system in signal communication with the signal processor;
a microprocessor circuit operating in accordance with a hypertext transfer protocol (HTTP) web server application, wherein the microprocessor circuit is one of integrated into the main controller and in communication with the main controller;
a microprocessor circuit operating in accordance with a hypertext transfer protocol (HTTP) web server application, wherein the microprocessor circuit is one of:
integrated into the main controller, and
in communication with the main controller; and
a bidirectional wireless data communication circuit enabling wireless communication between the main controller and at least one externally located browser enabling computing device;
storing data obtained from the condition monitoring sensor system in at least one of:
web application programming interface (API) enabling formatted data,
HyperText Markup Language (HTML) formatted data,
JavaScript formatted data,
JavaScript Object Notation (JSON),
Extensible Markup Language (XML),
Cascading Style Sheets (CSS) formatted data, and
image files;
compiling the stored data into at least one web page format for display as at least one web page;
communicating the at least one web page to a data recipient using a wireless communication protocol.

15. The method of use of an adaptive data conveyance condition monitoring apparatus as recited in claim 14, the method further comprising steps of:
accessing a web page using a browser enabling device;
submitting a request for condition data from said adaptive data conveyance condition monitoring apparatus through said web page;
conveying said request for condition data from said browser enabling device to said adaptive data conveyance condition monitoring apparatus;
responding to said request for condition data by said adaptive data conveyance condition monitoring apparatus, wherein said adaptive data conveyance condition monitoring apparatus compiles data into said at least one web page format for display as said at least one web page in accordance with said request; and
conveying said at least one web page format to said browser enabling device.

16. The method of use of an adaptive data conveyance condition monitoring apparatus as recited in claim 14, the method further comprising steps of:
identifying a scenario where data is missing assets; and
requesting said adaptive data conveyance condition monitoring apparatus provide said missing assets.

17. The method of use of an adaptive data conveyance condition monitoring apparatus as recited in claim 14, the method further comprising a step of:
embedding a condition monitoring application within at least one webpage for use within a browser.

18. The method of use of an adaptive data conveyance condition monitoring apparatus as recited in claim 14, the method further comprising a step of:
building an application within said browser;
automatically sizing a presentation of said condition data to accommodate a screen size of said display and said browser.

19. The method of use of an adaptive data conveyance condition monitoring apparatus as recited in claim 14, the method further comprising a step of:
constructing a response from HTML files stored in the memory device of the adaptive data conveyance condition monitoring apparatus.

20. The method of use of an adaptive data conveyance condition monitoring apparatus as recited in claim 14, the method further comprising a step of:
constructing a response from at least one of Cascading Style Sheets (CCS), JavaScript, and image files stored in the memory device of the adaptive data conveyance condition monitoring apparatus.
